(19) United States
(12) Patent Application Publication
(10) Pub. No.: US 2016/0324122 A1
(43) Pub. Date: Nov. 10, 2016

(54) CAT TOY HAVING A HOUSING AND A MOTORIZED DRIVE

(71) Applicant: HANGZHOU TIANYUAN PET PRODUCTS CO., LTD., HANGZHOU (CN)

(72) Inventor: PATRICK ALBUS, HONG KONG (CN)

(21) Appl. No.: 15/147,071

(22) Filed: May 5, 2016

(30) Foreign Application Priority Data
May 6, 2015 (DE) 202015003255.9

(51) Int. Cl. A01K 15/02; A01K 5/00

(52) U.S. Cl. CPC A01K 15/025; A01K 15/027; A01K 5/00

(57) ABSTRACT

A cat toy has a spherical housing formed of several housing shells. A motorized drive is operatively connected to said housing, for example, inside the housing and the cat toy is at least partially moved by the motorized drive. A lighting device is connected to the housing for emitting a directed light beam. The lighting device emits the light beam so as to generate a light spot.

### CROSS-REFERENCE TO RELATED APPLICATION

This application claims the priority, under 35 U.S.C. §119, of German application DE 20 2015 003 255.9, filed May 6, 2015; the prior application is herewith incorporated by reference in its entirety.

### BACKGROUND OF THE INVENTION

### Field of the Invention

The invention relates to a cat toy having a housing and having a motorized drive. The cat toy can be moved at least partially by the motorized drive.

A generic cat toy of this kind is known from the prior art. Said cat toy is in the form of a cat ball, wherein said ball serves as a housing and a string with a signal transmitter in the form of an artificial mouse is connected to said ball-like housing. A motorized drive in the form of an electric motor is arranged within the housing, wherein the cat toy can be driven by said electric motor, so that the ball or the housing is made to move in a rotating or wobbling manner. The ball or the housing moves along the ground and pulls the mouse along the floor by the string. This stimulates the play instinct of the cat to play and the cat can chase said moving cat ball or the trailing mouse.

However, this cat toy is not yet of optimum design. There is a risk the cats instinct of the cat losing interest in the cat toy after a relatively long period of play since the cat becomes accustomed to the rolling movement of the cat ball.

### SUMMARY OF THE INVENTION

It is accordingly an object of the invention to provide a cat toy which overcomes the above-mentioned and other disadvantages of the heretofore-known devices and methods of this general type and which provides for a cat toy that avoids the risk that the cat loses interest in the cat toy.

With the foregoing and other objects in view there is provided, in accordance with the invention, a cat toy, comprising:

a housing;

a motorized drive operatively connected to the housing, the motorized drive being configured to at least partially move the cat toy;

a lighting device connected to the housing and configured for emitting a directed light beam, the lighting device being configured to generate a light spot by way of the light beam.

In other words, the object on which the invention is based is achieved in that a light source is provided which emits a directed light beam. A light spot can be generated by way of the light beam. This has the advantage that the instinct of the cat to play is aroused not only by the cat toy itself being movable but additionally by a light spot being generated by the cat toy. The light spot also moves owing to the movement of the cat toy housing.

To this end, the housing has, in particular, a light exit opening, wherein the light beam is emitted by the lighting means through the light exit opening. In a particularly preferred refinement, the lighting means used is a laser. In this case, the wavelength and/or the power of the laser are/is adjusted such that the laser is not harmful to the human and/or animal eye. The wavelength of the laser lies, in particular, in the visible spectral range, in particular between 400 nm and 700 nm. The power of the laser preferably lies below 1 mW, preferably below 40 pW. The divergence of the light beam is preferably small. The size of the light spot is preferably less than 10 cm at a distance of one meter from the lighting means.

The lighting means is arranged within the housing and connected, in particular, to an electrical power supply in the form of a battery or a rechargeable battery. This electrical power supply is preferably the same power supply which is also used for operating the motorized drive.

The motorized drive is preferably in the form of an electric motor. In a preferred refinement, the power of the motorized drive can be subject to open-loop control and/or closed-loop control either continuously or in steps. As a result, it is possible for the cat toy to roll relatively quickly and/or to be moved in a wobbling manner in one power setting and to be moved only slightly in an another, lower power setting, wherein, however, it is easier for the cat to follow the light spot on the floor, on the walls or the like owing to this relatively slight movement.

The housing is preferably of spherical design. This allows effective rolling or wobbling movement of the cat toy.

A signal element is preferably present, wherein the signal element is connected to the housing by means of a rod, wherein the rod can be driven in a rotatable manner by means of the motorized drive. This arrangement can be called a motor-driven “cat rod”. The cat rod can preferably have an angled rod, wherein the rod is connected to the housing by way of one end and is fitted with a signal element at its other end. Since the rod is of angled design, the signal element is arranged eccentrically in relation to the drive shaft of the electric motor, this causing a wobbling movement of the cat rod. The signal element can be in the form of, for example, tufts of artificial feathers, fabric fringes or the like. If the cat toy, specifically the rod with the signal element in particular, is then moved by means of the motorized drive, both the housing and likewise the cat rods execute a movement, that is to say the signal element is likewise moved together with the rod, as a result of which the instinct of the cat to play is stimulated. The use of a rod in comparison to connecting the signal element to the housing by means of a string has the advantage that there is no string to get tangled up during a rolling movement of the cat toy. The length of the rod is preferably longer than the diameter of the housing. This prevents the housing from being able to roll over the rod. A switch or a corresponding operator control element with which the motorized drive and/or the lighting means can be switched is preferably provided on the housing.

The light exit opening is preferably arranged at a distance of substantially 90 degrees from the cat rod. The light exit opening is arranged substantially radially in relation to the rotor of the electric motor, so that, when the electric motor rotates, the housing and therefore also the light spot rotate with it. The light exit opening can be arranged, in particular, in an angular range of between 60 and 120 degrees measured relative to the longitudinal axis of the electric motor and/or to the longitudinal axis of the cat rod. The light exit opening is preferably arranged in an angular range of between 90 degrees and 120 degrees relative to the longitudinal direction of the electric motor or to the longitudinal axis of the cat rod on the housing, so that, when the cat toy is on the floor and the cat rod is projecting upward, the light spot is projected at least partially onto the floor.

The electric motor preferably drives an eccentric, specifically an eccentrically arranged flywheel. This has the advantage that the movement of the cat toy is random and wobbly, this further encouraging the instinct of the cat to play. It is further feasible for the controller of the electric motor to be designed in such a way that the power of the motor changes over time, so that the cat toy and therefore the light spot is moved “sometimes relatively frantically and sometimes relatively gently.”

In a preferred refinement, the cat toy has a food chamber, wherein said food chamber is connected to the surrounding area by means of a food removal opening. The housing can have, in particular, a plurality of housing shells, wherein at least two housing shells are connected in a detachable manner to one another. One of the housing shells can at least partially delimit a food chamber in which food for the cat can then be arranged. The instinct of the cat to play is further encouraged as a result since the cat attempts to reach the food which is contained in the food chamber. The housing shells can be connected to one another, in particular, by means of a screw connection. The food chamber can be located, in particular, at the opposite end to the cat rod, that is to say in a lower region of the cat toy. Owing to the motor-driven movement of the cat toy, the food which is contained in the food chamber is moved and the food, in particular small pieces of the food, falls/fall out. As a result, operating modes wherein a motorized drive is not used, but wherein the lighting means is nevertheless activated, are also feasible in particular. The cat attempts to reach the food in the chamber and in the process knocks against the housing by way of its paws or nose. As a result, the housing is moved and the light spot moves in the surrounding area. This likewise encourages the instinct of the cat to play. The food chamber can adjoin a battery compartment, this having the advantage that a compact construction is realized.

The housing is fitted with a weight in a lower region, in particular in the region of the lower housing shells. The weight serves as a counterweight to the cat rod.

The disadvantages mentioned in the introductory part are therefore avoided and corresponding advantages are achieved.

Other features which are considered as characteristic for the invention are set forth in the appended claims.

Although the invention is illustrated and described herein as embodied in a cat toy having a housing and having a motorized drive, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic perspective illustration of a cat toy according to the invention,

FIG. 2 is a schematic perspective, partially sectional illustration of the cat toy,

FIG. 3 is a schematic perspective, partially sectional illustration of the cat toy,

FIG. 4 is a schematic exploded illustration of the cat toy,

FIG. 5 is a schematic, perspective illustration of a lower housing shell of the cat toy,

FIG. 6 is a schematic, perspective illustration of a further housing shell comprising a battery compartment,

FIG. 7 is a schematic, perspective illustration of the battery compartment in an open position,

FIG. 8A is a schematic, perspective exploded illustration of a mount for a printed circuit board and for a light-emitting diode,

FIG. 8B is a schematic, perspective illustration of the mount for the printed circuit board and the light-emitting diode, and

FIG. 9 is a schematic, perspective illustration of an upper housing shell comprising an electric motor.

### DETAILED DESCRIPTION OF THE INVENTION

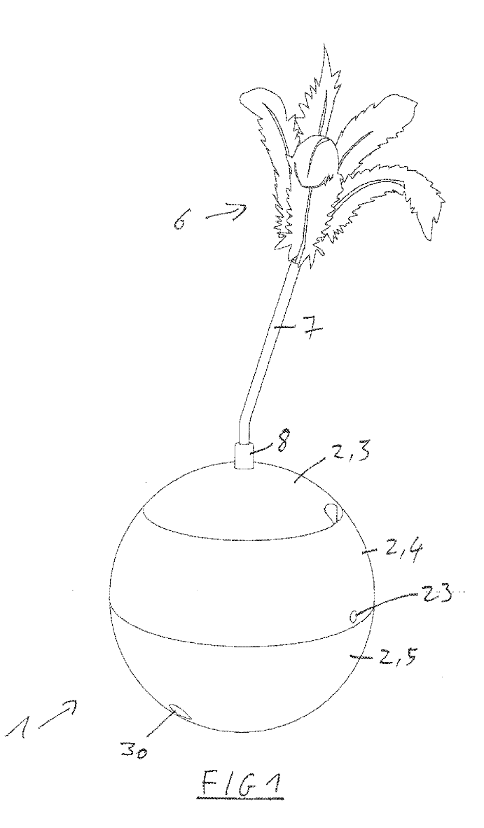

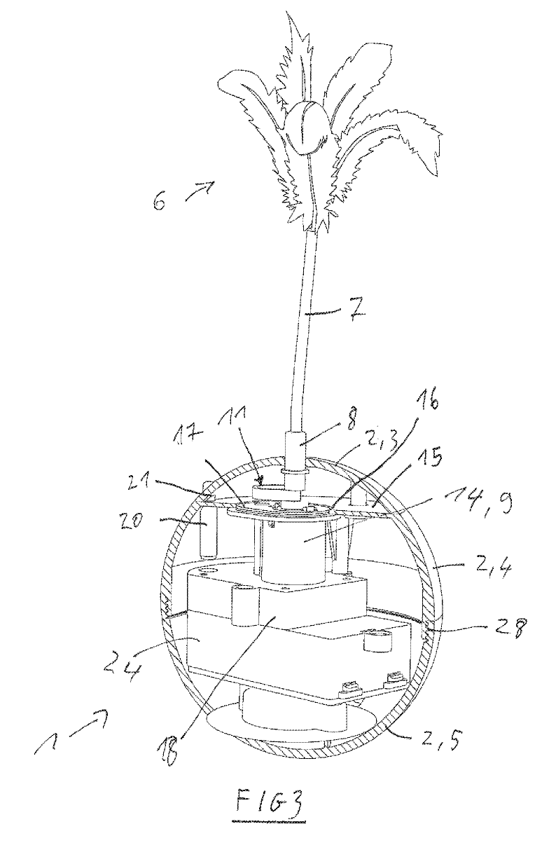

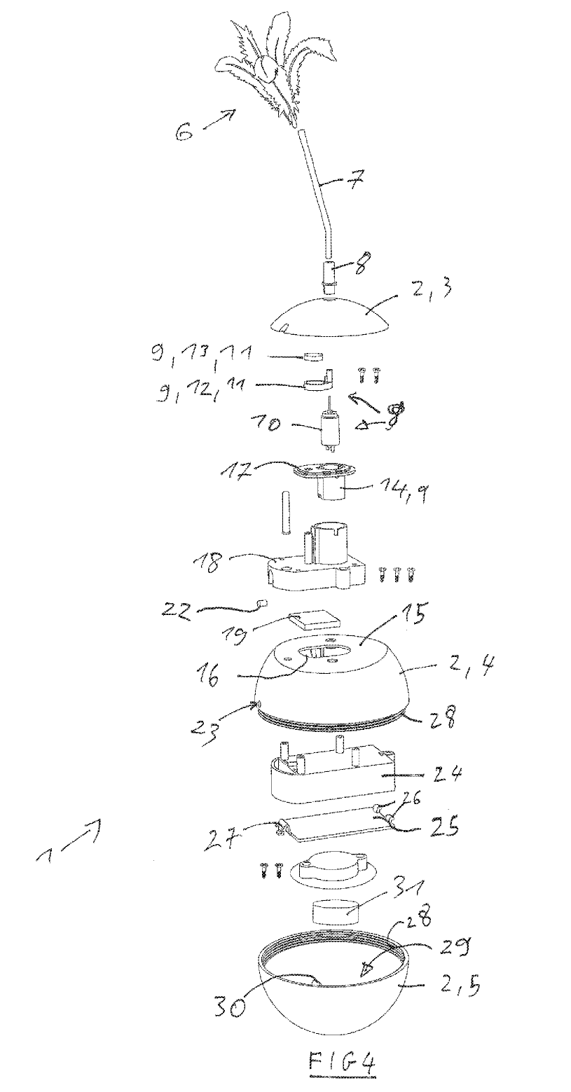

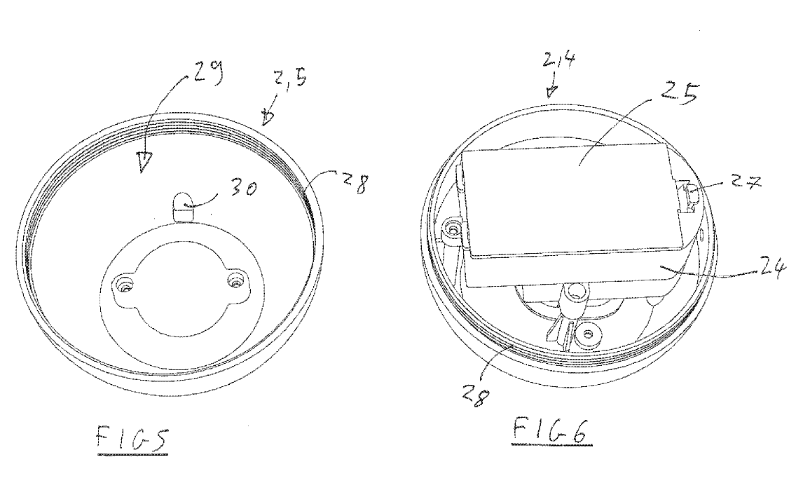

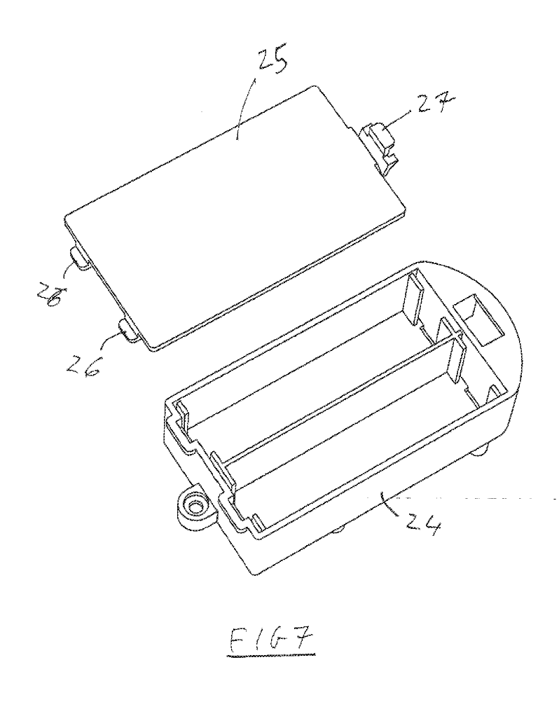

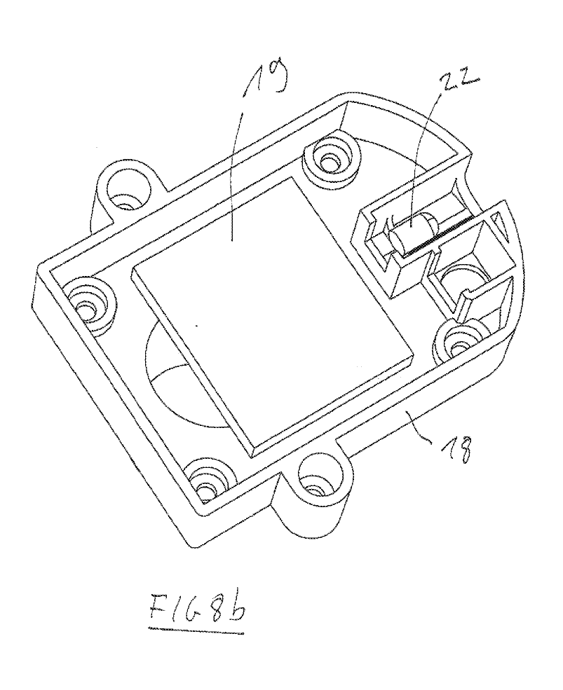

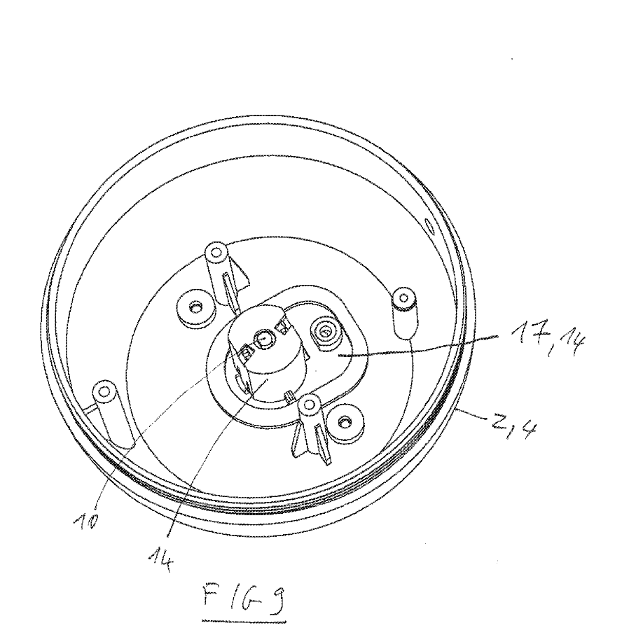

Referring now to the figures of the drawing in detail and first, particularly, to FIG. 1-5 thereof, there is shown a cat toy 1 in its entirety. FIGS. 5 to 9 show further details.

The cat toy 1 has a housing 2. The housing 2 is preferably of spherical design. In an alternative embodiment, the housing 2 can be of ellipsoidal design. The housing 2 has three partial housing shells, namely, an upper housing shell 3, a central housing shell 4 and a lower housing shell 5.

The cat toy 1 also has a signal element 6. The signal element 6 is connected in a functionally active manner to the housing 2. The signal element 6 can be formed, in particular, as feather tufts comprising preferably artificial feathers. In alternative embodiments, the signal element 6 can be in the form of a flag, a ball, or the like. In a preferred embodiment, the signal element 6 is connected to the housing 2 by means of a rod 7. The rod 7 is preferably connected to the housing 2 by means of a sleeve 8. The rod 7 is inserted into the sleeve 8. The signal element 6 together with the rod 7 can also be called a “cat rod.”

The cat toy 1 can now be made to move at least partially by a motorized drive 9. In a particularly preferred embodiment, the signal element 6 can be made to move by the motorized drive 9. To this end, the rod 7 is drive-coupled to the motorized drive 9. The motorized drive 9 has, in particular, an electric motor 10. The electric motor 10 drives the rod 7 in a functionally active manner by way of a corresponding shaft (not specifically indicated). The rod 7 together with the signal element 6 is made to perform a rotational movement in this case, so that the signal element 6 is moved. This stimulates the instinct of the cat to play and chase.

In a preferred embodiment, the rod 7 is of angled design, so that the longitudinal axis of the sleeve 8 does not point directly in the direction of the signal element 6. The signal element 6 is arranged eccentrically in relation to the sleeve 8 and therefore eccentrically in relation to the shaft of the electric motor 10. This increases the moment of inertia, as a result of which the signal element 6 executes a relatively large and relatively slow movement.

The cat toy 1 in its entirety is made to move by the motorized drive 9, in particular when the cat toy 1 is arranged on a flat floor. Owing to the spherical design of the housing 2, the housing 2 also begins to rotate, in particular against the direction of rotation of the rotor of the electric motor 10, and as a result to move forward. It is also feasible for the housing 2 to move in a rotatable manner on the spot. In a particularly preferred embodiment, the electric motor 10 is drive-coupled, in particular by means of a corresponding driveshaft, to an eccentric 11. The eccentric 11 has an eccentric disk mount 12 and an eccentric disk 13. The eccentric disk mount 12 is arranged in a rotatable manner by means of the electric motor 10 within the housing, specifically within the upper housing shell 3 in particular. The eccentric disk 13 is arranged eccentrically in relation to the shaft of the electric motor 10. The eccentric 11 forms, in particular owing to its flywheel, an unbalance which contributes, in particular, to the “erratic movement” of the housing 2. It is also feasible for the eccentric disk to be connected to the upper housing shell or to be guided so as to slide here.

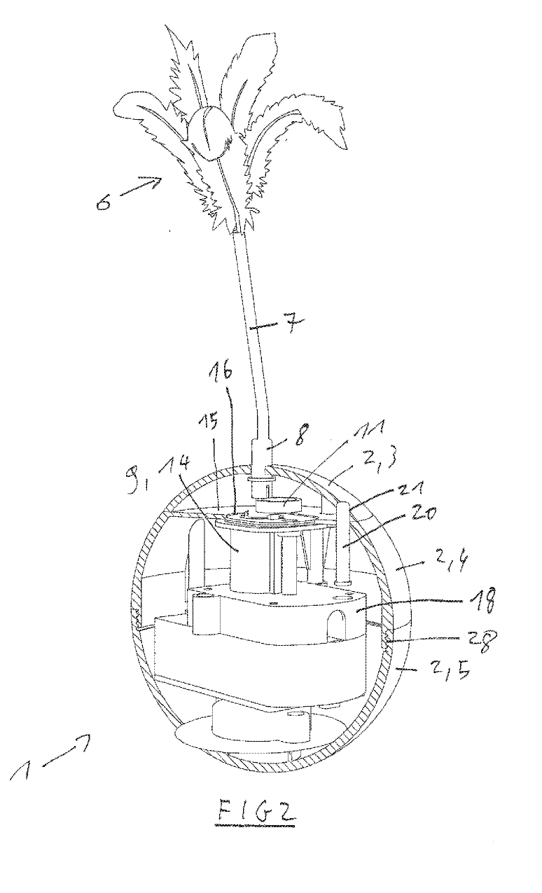

The motorized drive 9 also has a motor mount 14, wherein the electric motor 10 is accommodated, preferably in an interlocking and/or force-fitting manner, within the motor mount 14. FIGS. 2, 3, 4 and 9 clearly show that the central housing shell 4 has a separating wall 15, wherein this separating wall 15 has a passage opening 16. The motor mount 14 engages in an interlocking manner into the passage opening 16 by way of a corresponding mounting plate 17. Correspondingly in this case, the separating wall 15 is designed to separate off the upper end of the central housing shell 4 from the upper housing shell 3.

Secondly, the motor mount 14 engages into a further mount 18, wherein this mount 18 serves to hold a printed circuit board 19. The printed circuit board 19 serves to subject the electric motor 10 and therefore the motorized drive 9 to open-loop control and/or closed-loop control. An operator control element 20 is now provided, said operator control element serving to switch on and switch off the motorized drive 9. The operator control element 20 is firstly connected to the mount 18 and secondly the operator control element 20 passes through the housing 2, in particular in an opening 21, preferably in the upper housing shell 3. The operator control element 20 is in the form of a pin here. By pressing the pin 21 once or several times, the electric motor 10 is supplied with power or disconnected from the power supply by means of the printed circuit board 19, so that the cat toy 1 is correspondingly moved or not.

The disadvantages mentioned in the introductory part are avoided only by a lighting means 22 being provided, wherein a directed light beam can be emitted by means of the lighting means 22, and wherein a light spot can be generated by means of the light beam.

The lighting means 22 can be in the form of a light-emitting diode or in the form of a laser, for example. In a preferred embodiment, the lighting means 22 is in the form of a laser. The lighting means 22 is preferably in the form of a laser diode. The lighting means 22 is likewise arranged on the mount 18. The lighting means 22 can likewise be switched by means of the printed circuit board 19. The switching ability can once again be established by pressing the operator control element 20 once or several times here. The housing 2 then has a light exit opening 23, in particular on the central housing shell 4. If the cat toy 1 is then made to move by means of said motorized drive 9, the light spot is correspondingly also moved in the area surrounding the cat toy 1. The instinct of the cat to play is additionally stimulated in this way.

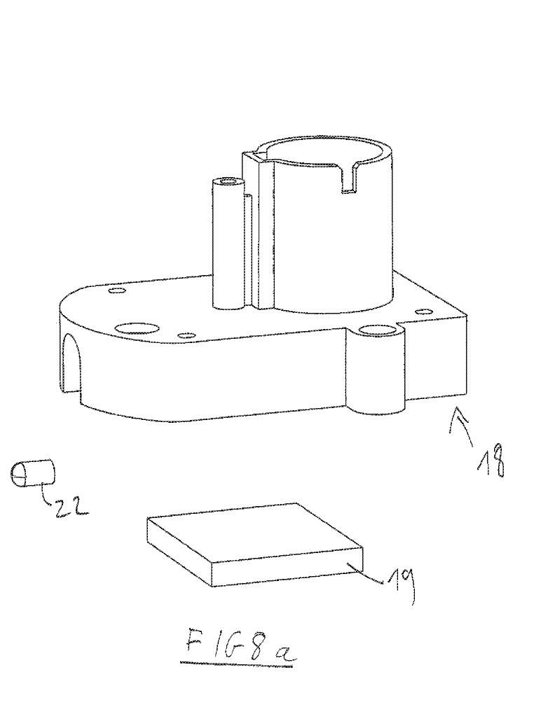

In order to then supply power to the motorized drive 9, the printed circuit board 19 and the lighting means 22, a battery compartment 24 (cf. FIG. 7) is provided. The battery compartment 24 is closed or can be closed by way of a battery compartment cover 25. The battery compartment cover 25 is connected to the battery compartment 24 such that it can be detached without a screw connection having to be released. The battery compartment 24 can be fitted, in particular, with batteries or rechargeable batteries. The battery compartment cover 25 is connected to the battery compartment 24, in particular by means of a releasable latching connection. The battery compartment cover 25 has two retaining lugs 26 at one end and a spring-action latching tab 27 at another end. The battery compartment 24 and the battery compartment cover 25 are likewise arranged in the interior of the housing 2.

It is possible for the user to open the housing 2 and to close said housing again by virtue of it being possible for the lower housing shell 5 to be separated from the central housing shell 4. The lower housing shell 5 is preferably connected only to the central housing shell 4 by means of a screw connection 28. As alternative embodiments, other interlocking or force-fitting connections can also be provided between the central housing shell 4 and the lower housing shell 5. For example, the central housing shell 4 and the lower housing shell 5 can be connected to one another by means of a bayonet fitting.

The housing 2 then has a food chamber 29. The food chamber 29 is at least partially delimited by the lower housing shell 5 here. The food chamber 29 is connected to the area surrounding the cat toy 1 by means of a food removal opening 30. The food chamber 29 adjoins the battery compartment 24. A compact design is realized in this way.

If the cat toy 1, specifically in particular the food chamber 29, is filled with cat food, the cat attempts to reach the food. The cat will also attempt to tip up the housing 2 and knock against the housing 2 by way of its paws, in particular in the region of the food chamber opening 30. As a result, the entire cat toy 1 is also made to move, as a result of which the instinct of the cat to play is once again encouraged.

In a preferred embodiment, the housing 2 is equipped with a weight 31 at the lower region, so that the signal element 6 projects upward, either obliquely upward or vertically, on flat floors too. In this case, the weight 31 is supported by a base plate 32 which is connected to the lower housing shell 5 by means of a screw connection. The base plate 32 is designed as a cover. The weight 31 is in the form of a cylindrical disk. As a result, the weight 31 is arranged in the lower housing shell 5 without play.

The motor mount 14, the mount 18 and/or the battery compartment 24 are connected to one another or to the corresponding housing shells 3 and 4 by means of screw connections, in particular.

The following is a summary list of reference numerals and the corresponding structure used in the above description of the invention:

1 Cat toy

2 Housing

3 Upper housing shell

4 Central housing shell

5 Lower housing shell

6 Signal element

7 Rod

8 Sleeve

9 Motorized drive

10 Electric motor

11 Eccentric

12 Eccentric disk mount

13 Eccentric disk

14 Motor mount

15 Separating wall

16 Passage opening

17 Mounting plate

18 Mount

19 Printed circuit board

20 Operator control element

21 Opening

22 Lighting device, light source

23 Light exit opening

24 Battery compartment

25 Battery compartment cover

26 Retaining lug

27 Latching tab

28 Screw connection

29 Food chamber

30 Food removal opening

31 Weight

32 Base plate

1. A cat toy, comprising:
a housing;
a motorized drive operatively connected to said housing, said motorized drive being configured to at least partially move the cat toy;
a lighting device connected to said housing and configured for emitting a directed light beam, said lighting device being configured to generate a light spot by way of the light beam.

2. The cat toy according to claim 1, wherein said motorized drive is disposed inside said housing.

3. The cat toy according to claim 1, wherein said lighting device is a laser.

4. The cat toy according to claim 1, which comprises a signal element and a rod connecting said signal element to said housing, wherein said motorized drive is configured to rotatably drive said rod.

5. The cat toy according to claim 4, wherein said rod is an angled rod.

6. The cat toy according to claim 1, wherein said motorized drive comprises an electric motor and an eccentric driven by said electric motor.

7. The cat toy according to claim 1, wherein said housing has a plurality of housing shells, wherein at least one of said housing shells at least partially delimits a food chamber formed with a food removal opening, and wherein said housing shell that delimits said food chamber is detachably connected to another one of said housing shells.

8. The cat toy according to claim 7, wherein said food chamber adjoins a battery compartment.

9. The cat toy according to claim 1, wherein said housing has a weight fitted in a lower region thereof.

10. The cat toy according to claim 1, wherein said housing has a plurality of housing shells and said housing has a weight fitted in a lower said housing shell.

11. The cat toy according to claim 1, wherein said housing is formed with a food chamber and an adjoining battery compartment.

12. The cat toy according to claim 1, wherein said housing is a substantially spherical housing.

13. The cat toy according to claim 1, wherein said housing is formed of a plurality of housing shells, and said housing is configured to be manually assembled and disassembled by a user.
